(19) United States
(12) Patent Application Publication
(10) Pub. No.: US 2015/0166100 A1
(43) Pub. Date: Jun. 18, 2015

(54) STEERING ANGULAR VELOCITY CONTROL APPARATUS FOR POWER STEERING SYSTEM AND METHOD THEREOF

(71) Applicants: Hyundai Motor Company, Seoul (KR); Kia Motors Corporation, Seoul (KR)

(72) Inventors: Chanjung KIM, Seoul (KR); Min-Jung KIM, Seongnam-si (KR); Seybok LEE, Seongnam-si (KR)

(73) Assignees: Hyundai Motor Company, Seoul (KR); Kia Motors Corporation, Seoul (KR)

(21) Appl. No.: 14/547,983

(22) Filed: Nov. 19, 2014

(30) Foreign Application Priority Data
Dec. 17, 2013 (KR) 10-2013-0156959

(51) Int. Cl. B62D 5/04

(52) U.S. Cl. CPC B62D 5/0466; B62D 5/0481

(57) ABSTRACT

An apparatus and method for controlling a steering angular velocity of a power steering system may include a vehicle velocity detection unit configured to detect a vehicle travelling velocity, a steering angle detection unit configured to detect a steering angle of a vehicle, a steering angular velocity detection unit configured to detect a steering angular velocity in real time, a motor driven power steering system (MDPS) configured to support steering and neutral position restoration torque of a steering wheel, and a controller configured to determine a target steering angular velocity according to the vehicle velocity and the steering angle when a neutral position restoration of the steering wheel is detected, detect a deviation between the steering angular velocity detected in real time and the target steering angular velocity, and control restoration torque through the MDPS.

### CROSS-REFERENCE TO RELATED APPLICATION

The present application claims priority to Korean Patent Application No. 10-2013-0156959 filed Dec. 17, 2013, the entire contents of which is incorporated herein for all purposes by this reference.

### BACKGROUND OF THE INVENTION

1. Field of the Invention

The present invention relates to a steering angular velocity active control apparatus of a power steering system, and more particularly, to an apparatus and a method of controlling a steering angular velocity of a power steering system, which actively compensate for a deviation between a steering angular velocity and a target steering angle when steering is completed and a steering wheel is restored to a neutral position, to secure stability in movement of a vehicle.

2. Description of Related Art

A driver performs steering in a predetermined travelling direction by using a power steering wheel while driving a vehicle, and when the steering is completed and the driver releases the power steering wheel, the steering wheel is restored to a neutral position by lateral force of the vehicle.

However, when the lateral force of the vehicle cannot overcome frictional force due to an influence by a suspension geometry state, an alignment state, suspension aging, a tire state, and the like, the steering wheel is stopped while the steering wheel is restored to a neutral position.

In this case, a motor driven power steering system (MDPS) generates restoring force to generate auxiliary torque so that the steering wheel may be restored to the neutral position.

A restoration logic of a steering wheel by using the MDPS applied to a vehicle up to now is set to generate predetermined restoration torque and assist in the restoration of the steering wheel to the neutral position regardless of a state of the vehicle.

However, a restored angle and velocity is different according to a state of the vehicle including a suspension geometry state, an alignment state, a suspension state, a tire state, friction between components, a component size, and the like, and a road state (friction value), and the restoration logic cannot provide an active support of restoration force in this condition, thereby affecting stability in the movement of the vehicle. Accordingly, adjustment of a steering wheel by a driver needs to be accompanied.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing stability in movement of a vehicle by actively compensating for a deviation of a steering angular velocity and a target steering angle when the steering wheel is restored to a neutral position after the steering is completed.

According to various aspects of the present invention, an apparatus for controlling a steering angular velocity of a power steering system may include a vehicle velocity detection unit configured to detect a vehicle travelling velocity, a steering angle detection unit configured to detect a steering angle of a vehicle, a steering angular velocity detection unit configured to detect a steering angular velocity in real time, a motor driven power steering system (MDPS) configured to support steering and neutral position restoration torque of a steering wheel, and a controller configured to determine a target steering angular velocity according to the vehicle velocity and the steering angle when the neutral position restoration of the steering wheel is detected, detect a deviation between the steering angular velocity detected in real time and the target steering angular velocity, and control restoration torque through the MDPS.

A map table for determining the target steering angular velocity according to the vehicle velocity and the steering angle, at which the steering wheel is restored to the neutral position, may be set in the controller.

The controller may proportional-integrate-derivatively (PID) control the deviation between the target steering angular velocity and the steering angular velocity detected in real time and may determine the restoration torque.

According to various aspects of the present invention, a method of controlling a steering angular velocity of a power steering system may include detecting a vehicle velocity and a steering angle when a start of neutral position restoration of a steering wheel is detected, and determining a target steering angular velocity, detecting a current steering angular velocity in real time, comparing the current steering angular velocity and the target steering angular velocity, and detecting generation of a deviation between the steering angular velocity detected in real time and the target steering angular velocity, and determining restoration torque according to the deviation, and controlling torque of an MDPS when the generation of the deviation is detected through the comparison of the current steering angular velocity and the target steering angular velocity.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram schematically illustrating an exemplary steering angular velocity control apparatus of a power steering system according to the present invention.

FIG. 2 is a flowchart illustrating an exemplary steering angular velocity control process of a power steering system according to the present invention.

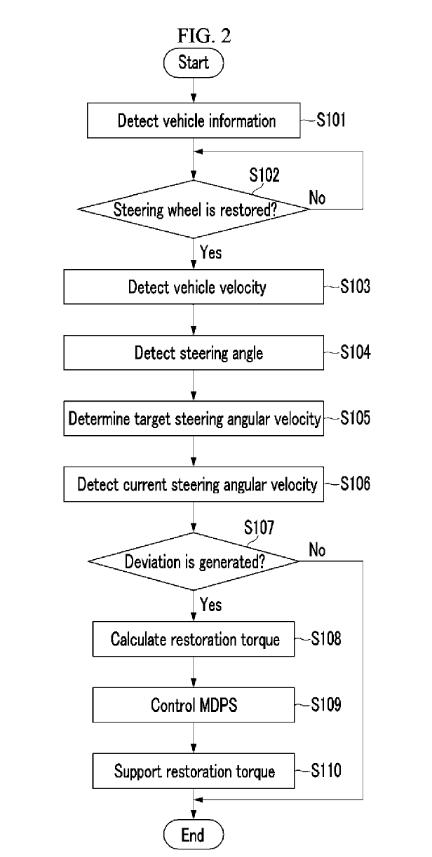

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

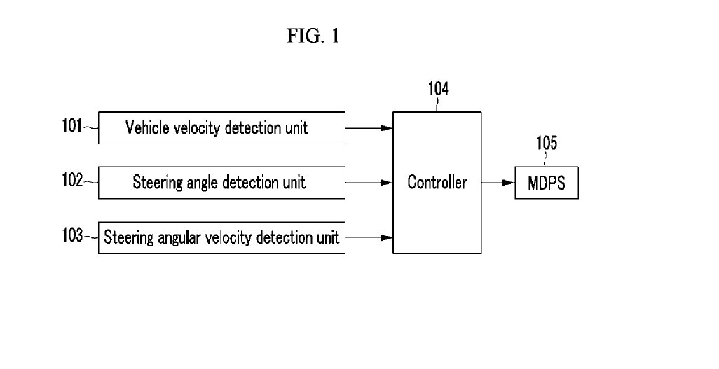

FIG. 1 is a diagram schematically illustrating a steering angular velocity control apparatus of a power steering system according to various embodiments of the present invention.

Referring to FIG. 1, the present invention includes a vehicle velocity detection unit 101, a steering angle detection unit 102, a steering angular velocity detection unit 103, a controller 104, and a motor driven power steering system (MDPS) 105.

The vehicle velocity detection unit 101 detects a vehicle travelling velocity from revolutions per minute (rpm) of an output axis of a transmission, and applies information on the detected vehicle travelling velocity to the controller 104 in a form of an electrical signal.

The steering angle detection unit 102 detects a steering angle, at which a steering wheel is restored to a neutral position by lateral force of the vehicle according to the release of the steering wheel after the steering is completed, and applies the information on the detected steering angle to the controller 104 in the form of an electrical signal.

The steering angular velocity detection unit 103 detects a steering angular velocity, at which the steering wheel is restored to the neutral position by lateral force of the vehicle according to the release of the steering wheel after the steering is completed, and applies the information on the detected steering angular velocity to the controller 104 in the form of an electrical signal.

The controller 104 determines a target steering angular velocity according to the information on the vehicle velocity applied from the vehicle velocity detection unit 101 and the information on the steering angle applied to the steering angle detection unit 102, and compares the steering angular velocity detected by the steering angular velocity detection unit 103 in real time and the target steering angular velocity to extract a deviation between the steering angular velocity and the target steering angular velocity.

The controller 104 calculates restoration torque by proportional integrate derivative (PID) control according to the deviation of the steering angular velocities, and then controls support torque of the MDPS 105.

A map table for determining a target steering angular velocity according to a vehicle velocity and a steering angle is set in the controller 104.

The MDPS 105 assists in the restoration torque of the steering wheel according to a control signal applied from the controller 104 to make the steering wheel be stably restored to the neutral position.

An operation of the present invention including the aforementioned function will be described below.

The torque assistance by the MDPS when a driver performs steering by using the steering wheel in a travelling direction while driving a vehicle to which the power steering system according to various embodiments of the present invention is applied is the same as or similar to that of the related art, so that a description thereof will be omitted.

The present invention is a technique of actively controlling restoration torque of the steering wheel in the power steering system, which will be described only.

In the state where a vehicle to which the power steering system according to various embodiments of the present invention is applied is travelled, the controller 104 detects general driving information about the vehicle (S101), and determines whether the steering wheel is restored to the neutral position based on the information on the steering angle of the steering angle detection unit 102 (S102).

When it is determined that the steering wheel is restored to the neutral position in operation S102, the controller 104 detects a current vehicle travelling velocity from the vehicle velocity detection unit 101 (S103), and detects a steering angle, at which the steering wheel is restored to the neutral position, from the steering angle detection unit 102 (S104).

The controller 104 determines a target steering angular velocity by applying the vehicle velocity detected in operation S103 and the steering angle detected in operation S104 to the set map table (S105).

When the target steering angular velocity is determined in operation S105, the controller 104 detects a current steering angular velocity in real time from the steering angular velocity detection unit 103 (S106), and compares the steering angular velocity detected in real time and the target steering angular velocity and determines whether a deviation is generated between the target steering angular velocity and the actual steering angular velocity (S107).

When the deviation is generated between the target steering angular velocity and the actual steering angular velocity in operation S107, the controller 104 calculates restoration torque by the PID control (S108), and then supports neutral position restoration torque of the steering wheel by controlling the MDPS 105 (S109 and S110).

According to various embodiments of the present invention, the present invention compensates for the deviation between the steering angular velocity and the target steering angle by the PID control when the steering wheel is restored to the neutral position after the steering is completed, and then controls the torque of the MDPS, thereby providing stability and reliability in restoration of the steering wheel to the neutral position. Further, the present invention may actively control the restoration of the steering wheel through the control logic without changing hardware, thereby providing stability in movement of the vehicle.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for controlling a steering angular velocity of a power steering system, comprising:
a vehicle velocity detection unit configured to detect a vehicle travelling velocity;
a steering angle detection unit configured to detect a steering angle of a vehicle;
a steering angular velocity detection unit configured to detect a steering angular velocity in real time;
a motor driven power steering system (MDPS) configured to support steering and neutral position restoration torque of a steering wheel; and
a controller configured to determine a target steering angular velocity according to the vehicle velocity and the steering angle when a neutral position restoration of the steering wheel is detected, detect a deviation between the steering angular velocity detected in real time and the target steering angular velocity, and control restoration torque through the MDPS.

2. The apparatus of claim 1, wherein a map table for determining the target steering angular velocity according to the vehicle velocity and the steering angle, at which the steering wheel is restored to the neutral position, is set in the controller.

3. The apparatus of claim 1, wherein the controller proportional-integrate-derivatively (PID) controls the deviation between the target steering angular velocity and the steering angular velocity detected in real time and determines the restoration torque.

4. A method of controlling a steering angular velocity of a power steering system, comprising:
detecting a vehicle velocity and a steering angle when a start of neutral position restoration of a steering wheel is detected, and determining a target steering angular velocity;
detecting a current steering angular velocity in real time, comparing the current steering angular velocity and the target steering angular velocity, and detecting generation of a deviation between the steering angular velocity detected in real time and the target steering angular velocity; and
determining restoration torque according to the deviation, and controlling torque of an MDPS when the generation of the deviation is detected through the comparison of the current steering angular velocity and the target steering angular velocity.
